(19) United States
(12) Patent Application Publication
(10) Pub. No.: US 2022/0065690 A1
(43) Pub. Date: Mar. 3, 2022

(54) STATISTICAL IMAGE PROCESSING-BASED ANOMALY DETECTION SYSTEM FOR CABLE CUT PREVENTION

(71) Applicant: NEC Laboratories America, Inc., Princeton, NJ (US)

(72) Inventors: Shaobo HAN, Princeton, NJ (US); Ming-Fang HUANG, Princeton, NJ (US); Yuheng CHEN, South Brunswick, NJ (US); Milad SALEMI, Cross River, NY (US); Ting WANG, West Windsor, NJ (US); Yoshiaki AONO, Tokyo (JP); Glenn WELLBROCK, Wylie, TX (US); Tiejun XIA, Richardson, TX (US)

(73) Assignees: NEC LABORATORIES AMERICA, INC, Princeton, NJ (US); NEC Corporation, Tokyo (JP); Verizon Patent and Licensing Inc., Basking Ridge, NJ (US)

(21) Appl. No.: 17/410,820

(22) Filed: Aug. 24, 2021

Related U.S. Application Data
(60) Provisional application No. 63/069,802, filed on Aug. 25, 2020.
(60) Provisional application No. 63/140,985, filed on Jan. 25, 2021.

(51) Int. Cl. G01H 9/00; G06E 3/00; G01D 5/353

(52) U.S. Cl. CPC G01H 9/004; G01D 5/35303; G06E 3/005

(57) ABSTRACT

Aspects of the present disclosure describe distributed fiber optic sensing (DFOS) systems, methods, and structures that advantageously enable anomaly detection resulting from construction—or other activity based on image processing that may advantageously detect/notify/prevent damage to a fiber optic network infrastructure before such damage occurs.

### CROSS REFERENCE

This disclosure claims the benefit of U.S. Provisional Patent Application Ser. No. 63/069,802 filed Aug. 25, 2020 and U.S. Provisional Patent Application Ser. No. 63/140,985 filed Jan. 25, 2021, the entire contents of each is incorporated by reference as if set forth at length herein.

### TECHNICAL FIELD

This disclosure relates generally to fiber optic telecommunications networks and distributed fiber optic sensing (DFOS) systems, methods, and structures. More specifically, it pertains to systems, methods, and structures that may advantageously utilize DFOS techniques to prevent fiber optic damage before such damage occurs.

### BACKGROUND

Global networking service providers have necessarily deployed large scale, fiber optic network infrastructures—reaching almost everywhere on Earth—to provide for an ever increasing, insatiable demand for telecommunications bandwidth including the Internet. As is readily understood and appreciated, damage to the fiber optic network infrastructure—including fiber cuts—precipitates enormous disruption to contemporary society. Consequently, systems, methods and structures that provide the ability to detect activity proximate to a fiber optic network infrastructure that threaten the operation of such infrastructure would represent a significant and most welcome addition to the art as it may prevent any damage and resulting consequences.

### SUMMARY

An advance in the art is made according to aspects of the present disclosure directed to distributed fiber optic sensing (DFOS) systems, methods, and structures that provide for construction—or other activity—anomaly detection based on image processing that may advantageously detect/notify/prevent damage to a fiber optic network infrastructure before such damage occurs.

In sharp contrast to the prior art, systems, methods, and structures according to aspects of the present disclosure provides such anomaly detection based on statistical image processing including two major operations on the DFOS waterfall images including

### Image Binarization and Spatio-Temporal Filtering.

Advantageously, our Image binarization operates to determine location-specific cutoff points that are derived from data based on a specified level of false alarm rate, and to convert waterfall images into black-and-white images that advantageously removes unnecessary details while reducing storage and processing cost(s).

Our Spatio-temporal filtering operates to reduce false alarms by removing various kinds of background noise(s). Of further advantage, our filter template employed is customizable to the spatio-temporal patterns of target events of interest.

Our inventive technique is a hybrid, knowledge-based and data-driven technique including our novel algorithmic adaptive binarization and filter templates. With our Adaptive binarization technique, instead of setting a global intensity threshold and applying it to an entire fiber optic cable, our technique first surveys intensity level(s) of normal floor vibrations at each fiber optic cable point, and then derives its own cutoff point, which ensures a false alarm rate below a specified level if no signal is present. These cutoff points can adapt to day/night/weekend/week day and weather-ground conditions, without the need of human intervention. With our Filter templates—although the statistical characteristics of the construction signals are unknown and difficult to model—prior knowledge does exist, such as the hitting frequency, temporal duration, and spatial influence range under different ground-soil and weather conditions. According to our inventive technique, spatio-temporal patterns are visually different to the human eye from other vibrations caused by normal traffic and environment noise. The false alarm rate can be further reduced by distilling such human knowledge into our anomaly detection system and improve the detection rate. Guided by such knowledge, we developed different architectures of spatio-temporal filters for different target signal patterns, by applying different kernel size of median filters, designing cascade of multiple filters, and using subtraction operators.

### BRIEF DESCRIPTION OF THE DRAWING

A more complete understanding of the present disclosure may be realized by reference to the accompanying drawing in which:

FIG. 1 is a schematic diagram of an illustrative distributed fiber optic sensing system and operation generally known in the art;

FIG. 2 is a flow diagram illustrating an overall method according to aspects of the present disclosure;

FIG. 3 is a schematic block diagram showing an illustrative DFOS sensor network overlaid on a fiber optic network and a plot illustrating sensing signal intensity for normal conditions and construction activity according to aspects of the present disclosure;

FIG. 4 is a flow diagram showing a detailed waterfall anomaly detection method according to aspects of the present disclosure;

FIG. 5 is a schematic diagram illustrating operation P1 of the FIG. 4 flow diagram according to aspects of the present disclosure;

FIG. 6 is a schematic diagram illustrating operation P2 of the FIG. 4 flow diagram according to aspects of the present disclosure;

FIG. 7 is a schematic diagram illustrating operation P3 of the FIG. 4 flow diagram according to aspects of the present disclosure;

FIG. 8 is a schematic diagram illustrating operation P4 of the FIG. 4 flow diagram according to aspects of the present disclosure;

FIG. 9(A) and FIG. 9(B) are a series of plots illustrating a test example of an excavator hitting a fiber optic cable according to aspects of the present disclosure;

FIG. 10(A) and FIG. 10(B) are a series of plots illustrating a second test example of an excavator hitting a fiber optic cable according to aspects of the present disclosure;

FIG. 11(A) and FIG. 11(B) are a series of plots illustrating a third test example of an excavator hitting a fiber optic cable according to aspects of the present disclosure;

FIG. 12 is a schematic diagram showing an illustrative display of an anomaly detection system according to aspects of the present disclosure; and

FIG. 13 is a flow diagram showing an illustrative fiber optic cable safety protection system operation from input sensing to output warning according to aspects of the present disclosure.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

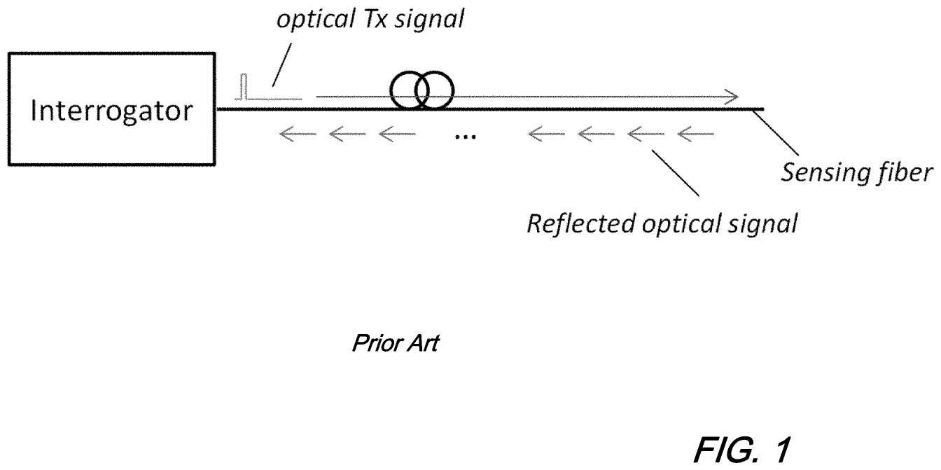

By way of some additional background—and with reference to FIG. 1 which is a schematic diagram of an illustrative distributed fiber optic sensing system generally known in the art—we begin by noting that distributed fiber optic sensing (DFOS) is an important and widely used technology to detect environmental conditions (such as temperature, vibration, stretch level etc.) anywhere along an optical fiber cable that in turn is connected to an interrogator. As is known, contemporary interrogators are systems that generate an input signal to the fiber and detects/analyzes the reflected/scattered and subsequently received signal(s). The signals are analyzed, and an output is generated which is indicative of the environmental conditions encountered along the length of the fiber. The signal(s) so received may result from reflections in the fiber, such as Raman backscattering, Rayleigh backscattering, and Brillion backscattering. It can also be a signal of forward direction that uses the speed difference of multiple modes. Without losing generality, the following description assumes reflected signal though the same approaches can be applied to forwarded signal as well.

As will be appreciated, a contemporary DFOS system includes an interrogator—and accompanying analysis structure/functions—that periodically generates optical pulses (or any coded signal) and injects them into an optical fiber. The injected optical pulse signal is conveyed along the optical fiber.

At locations along the length of the fiber, a small portion of signal is reflected and conveyed back to the interrogator. The reflected signal carries information the interrogator uses to detect, such as a power level change that indicates—for example—a mechanical vibration.

The reflected signal is converted to electrical domain and processed inside the interrogator. Based on the pulse injection time and the time signal is detected, the interrogator determines at which location along the fiber the signal is coming from, thus able to sense the activity of each location along the fiber.

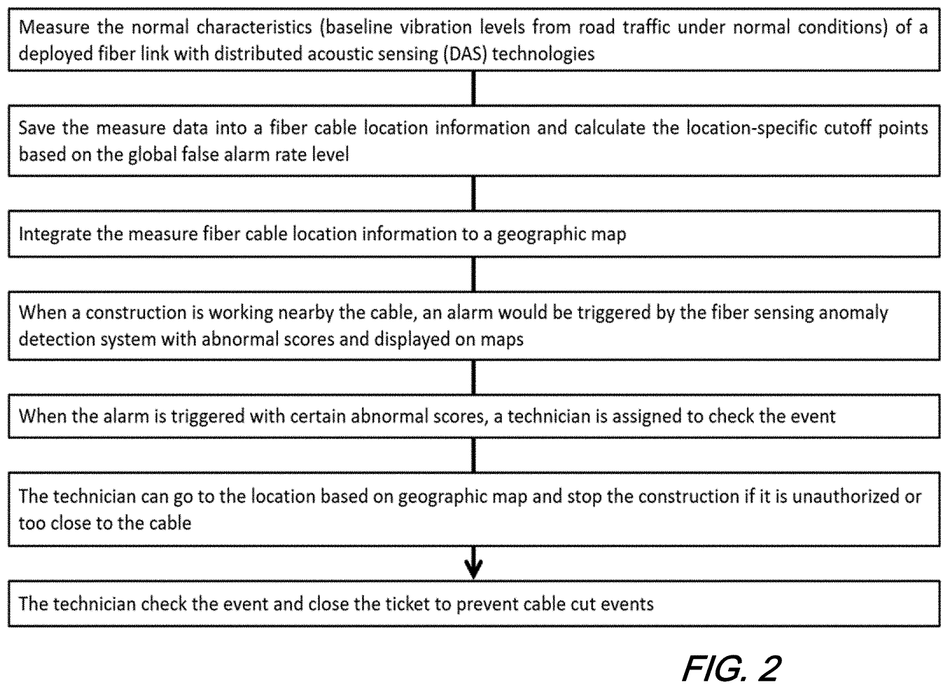

FIG. 2 is a flow diagram illustrating an overall method according to aspects of the present disclosure. As illustrated in that flow diagram, the illustrative method begins a Step 1 by measuring normal characteristics including baseline vibration levels from—for example—road traffic under normal conditions—of a deployed fiber optic fiber link that is part of a distributed acoustic sensing system.

At a Step 2, the measured data is saved into a fiber cable location information data store and a location-specific cutoff point is determined based on a global false alarm level.

At a Step 3, the measured fiber cable location information is integrated into a geographic map.

At a Step 4, when a construction operation is taking place nearby (proximate to) the fiber, an alarm is triggered by the fiber sensing anomaly detection system with abnormal scores displayed on maps for viewing or output to a user or other system.

At a Step 5, when an alarm is triggered with a pre-determined abnormal score, a technician is assigned to check the event(s). At a Step 6, the technician may visit the location based on the geographic map and evaluate/stop the construction operation I it is unauthorized or too close to the cable. Finally, at a Step 7, the technician may check the event and close any trouble ticket that may have been generated.

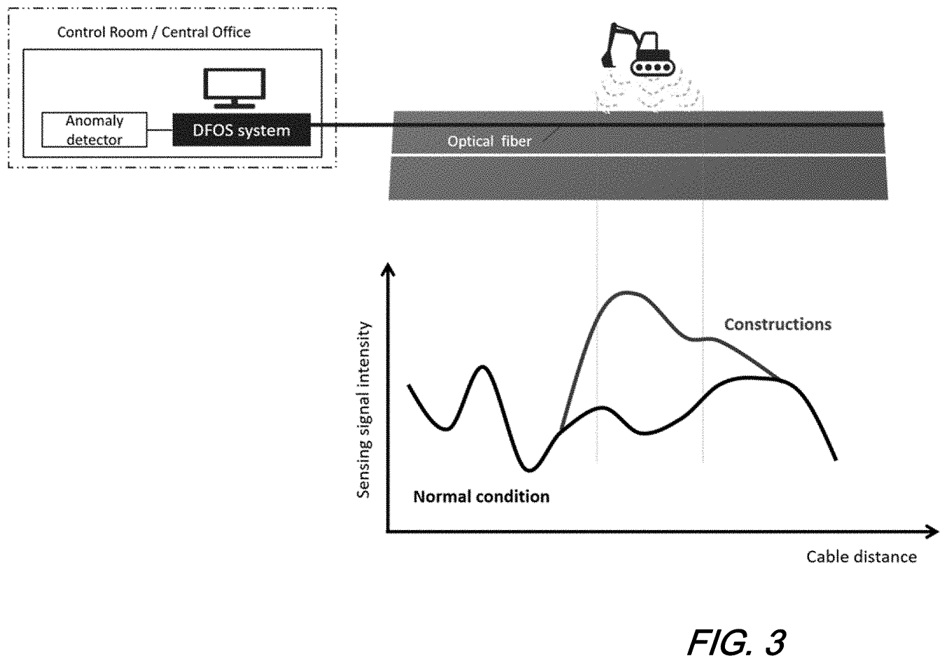

FIG. 3 is a schematic block diagram showing an illustrative DFOS sensor network overlaid on a fiber optic network and a plot illustrating sensing signal intensity for normal conditions and construction activity according to aspects of the present disclosure. As illustratively shown in that schematic diagram, an optical sensing system (DFOS) and anomaly detector is shown located in a central office/control room from which it may operate/monitor an entire fiber optic cable route that is deployed (in the field). The DFOS system is optically connected/in communication with such deployed field fiber optic (sensing fiber) to provide sensing functions along the length of the fiber.

Advantageously, and as will be readily appreciated by those skilled in the art, the deployed sensing fiber optic can be a dark fiber or an in-service, operational fiber that carries live telecommunications traffic. Inset graph in the figure shows an illustrative signal intensity map from as determined by the DFOS using the deployed, in-field fiber optic as sensor. Those skilled in the art will understand and appreciate that during normal conditions that include primarily road traffic and environmental noise, a signal intensity is lower than any signal intensity associated with proximate construction activities.

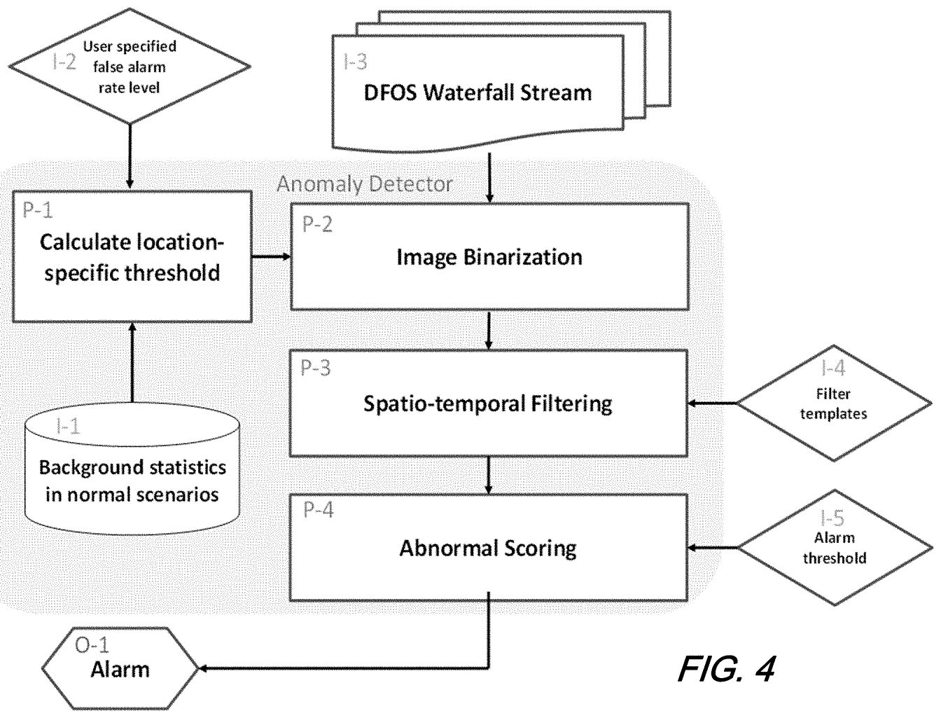

FIG. 4 is a flow diagram showing a detailed waterfall anomaly detection method according to aspects of the present disclosure. As used in this figure, “I” designates inputs, designates procedures, and “0” designates outputs. They are explained in detail below.

Operationally, our inventive system receives as inputs the following.

I-1: Normal Scenario Statistics

After a certain period of time of field condition monitoring by our DFOS system, sensing signal intensity statistics are obtained as a system baseline which includes signals from road traffic and also background noise for an entire cable route (without construction operations).

1-2: User Specified False Alarm Level

Users of our system may adjust an upper bound of a false alarm level, based on the intensity of a target signal and a user tolerance to missing alarms. Accordingly, an individual cutoff point is generated for every location along the sensing fiber optic based on the normal condition statistics.

1-3: DFOS Waterfall Stream

Snapshots of waterfall data from the DFOS sensor fiber optic based on a sliding time window.

1-4: Filter Templates

Advantageously, different “template” filter architectures are designed for different target signals. Accordingly, users can plug-in the ones for the most frequent threaten events or use multiple of them in parallel.

1-5: Alarm Threshold

An abnormal score is determined to be a total number of white pixels at each fiber optic cable point within each time window. A threat level (high, mid, low) can be assigned based on setting multiple thresholds on abnormal scores. A final alarm decision can be made by continuous monitoring the waterfall and determining a cumulative abnormal score across multiple time frames. An alarm will be triggered if the abnormal score is higher than the threshold and displayed on a map for notification to appropriate persons or systems.

Operationally, our inventive system and method may include the following illustrative procedures:

P-1: Location-Specific Cutout Points in Normal Condition

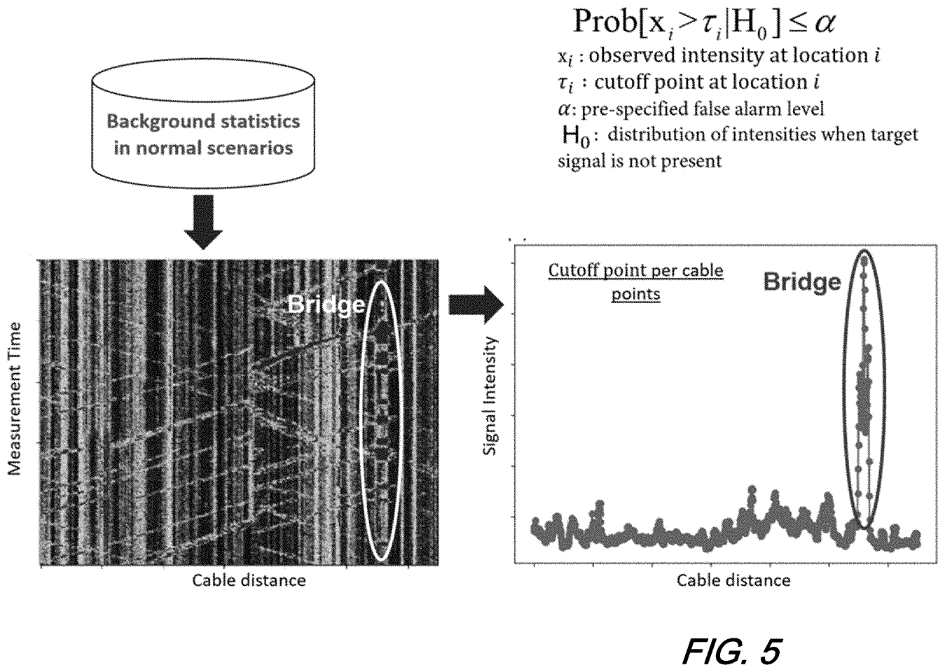

FIG. 5 is a schematic diagram illustrating operation P1 of the FIG. 4 flow diagram according to aspects of the present disclosure. In particular, the figure shows the procedure P-1 in a normal condition as a baseline (without constructions). After receiving data from the DFOS system for a certain period of time—i.e., few hours or few days or other user-defined period—the signal intensity can be shown which may include road traffic patterns, bridge vibration patterns and stationary noise from surrounding environments. By constraining the false alarm rate below certain level, the cutoff point at every cable location of an entire route can be set as shown in the figure. It can be seen that in a proximate area of bridges, the cutoff points are higher due to larger vibration signals being generated.

P-2: Image Binarization

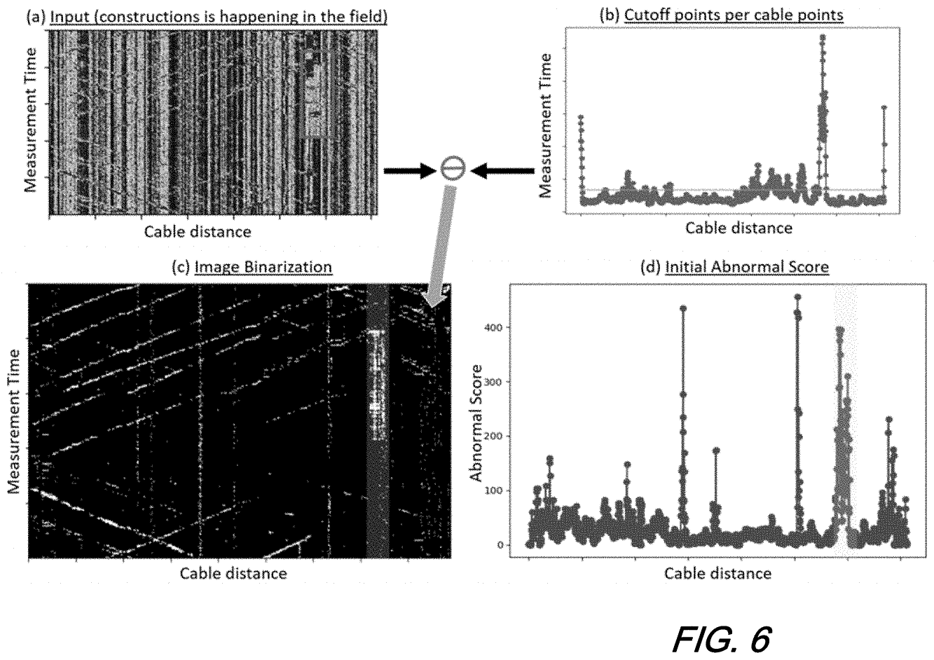

FIG. 6 is a schematic diagram illustrating operation P2 of the FIG. 4 flow diagram according to aspects of the present disclosure. Operationally, an anomaly condition is detected where construction is located in the outlined area of the waterfall plot. By normalizing signals by computing its Z-score, an initial binary decision can be obtained by image binarization, as displayed. Additionally, an initial abnormal score, can be achieved by counting total pixel numbers of each location (column). Note that for each of the fiber optic cable points, pixels exhibiting a top [x] percent of the intensity are considered as rare and flagged out as “initial anomaly” where [x] percent corresponds to the false alarm level defined by the user.

P-3: False Alarm Control via Median Filter

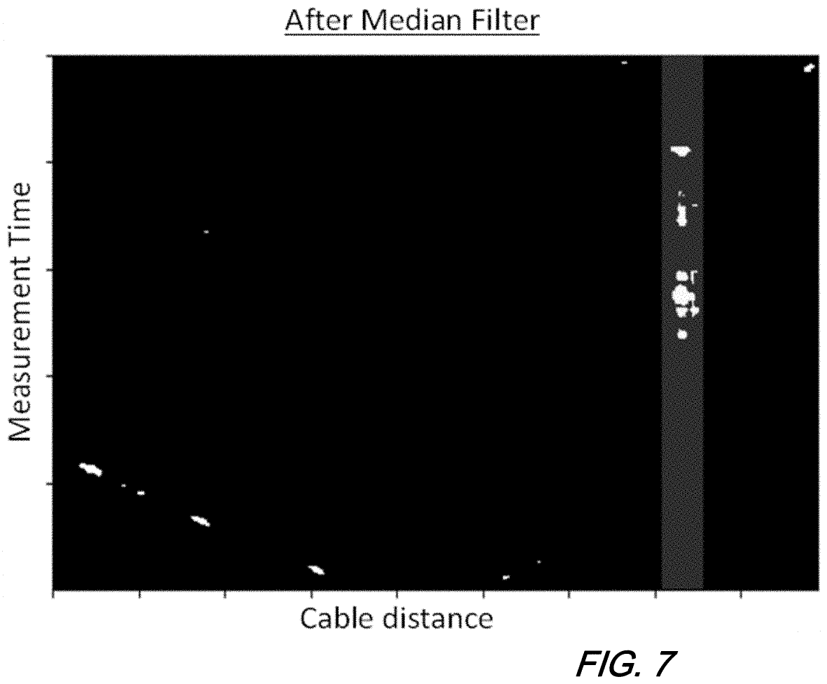

FIG. 7 is a schematic diagram illustrating operation P3 of the FIG. 4 flow diagram according to aspects of the present disclosure. By advantageously employing a median filter with customized kernel size, some of noises (e.g. road traffic noise, bridge noise and ambient noise) can be reduced by spatio-temporal filtering. It can be seen from the figure, that abnormal events and only a few traffic noises remain after sifting/filtering by a median filter.

P-4: Computing abnormal scores

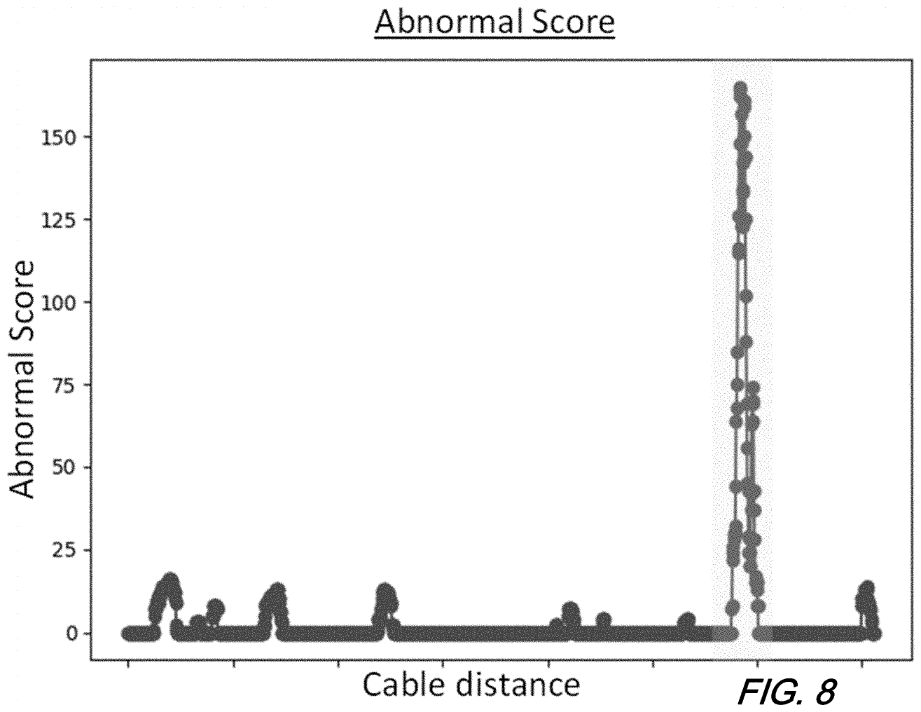

FIG. 8 is a schematic diagram illustrating operation P4 of the FIG. 4 flow diagram according to aspects of the present disclosure. This FIG. 8 shows the abnormal score. For each fiber optic cable point, the abnormal score is calculated as the total number of “anomaly” pixels determined previously. Hence, the remaining traffic noise receives lower scores than construction events, as they are not location persistent. There is a benefit to monitor abnormal score across time or compute a cumulative abnormal score—the non-threaten events such as construction machine moving along the cable would not cause a false alarm as the anomaly location indicated by abnormal score is also time-varying.

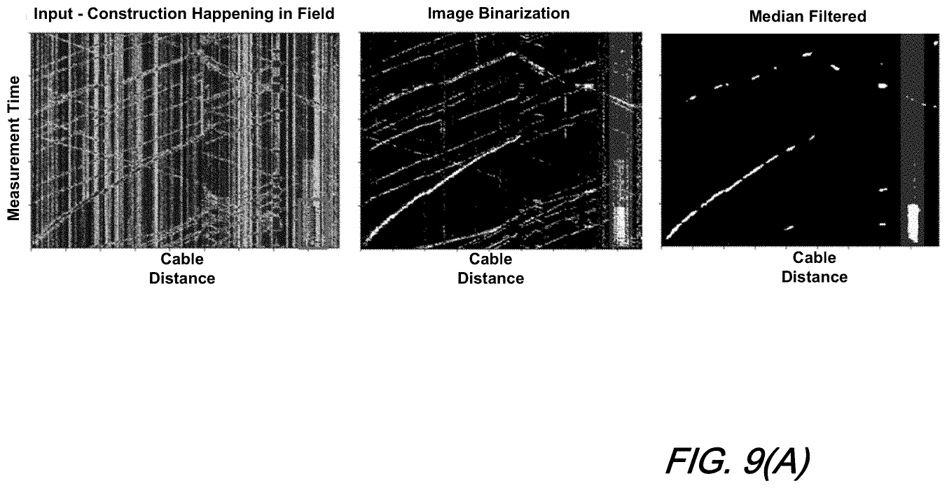

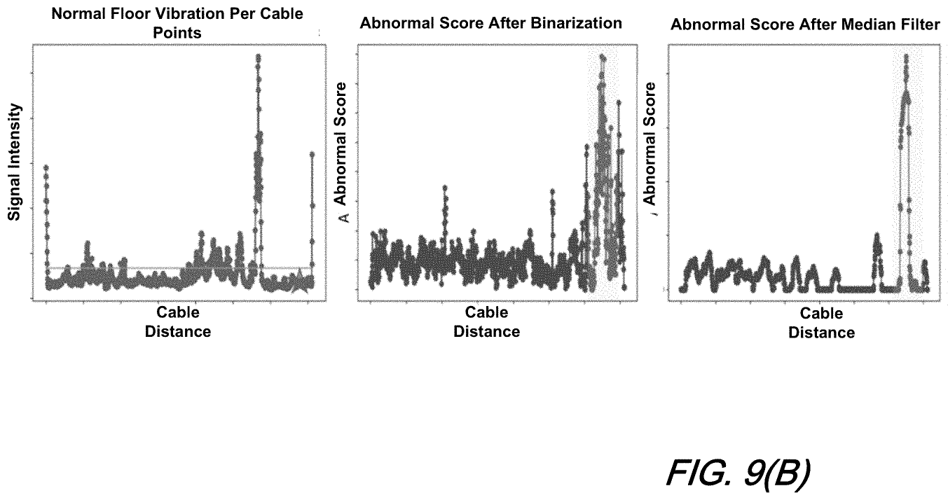

FIG. 9(A) and FIG. 9(B) are a series of plots illustrating a test example of an excavator hitting a fiber optic cable according to aspects of the present disclosure.

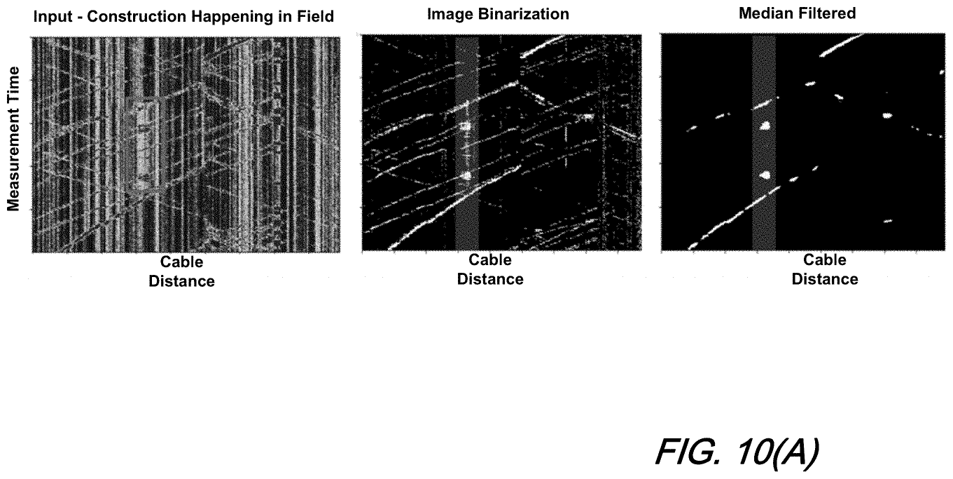

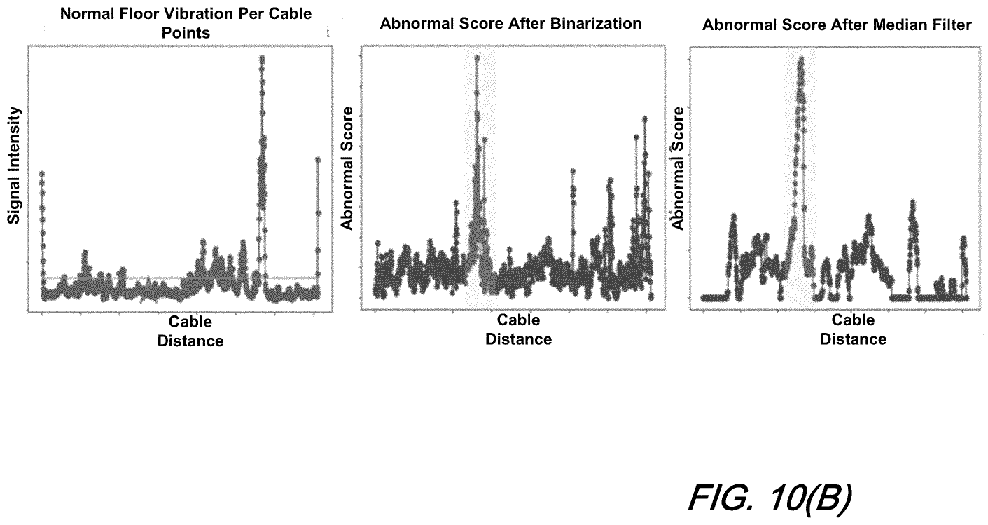

FIG. 10(A) and FIG. 10(B) are a series of plots illustrating a second test example of an excavator hitting a fiber optic cable according to aspects of the present disclosure.

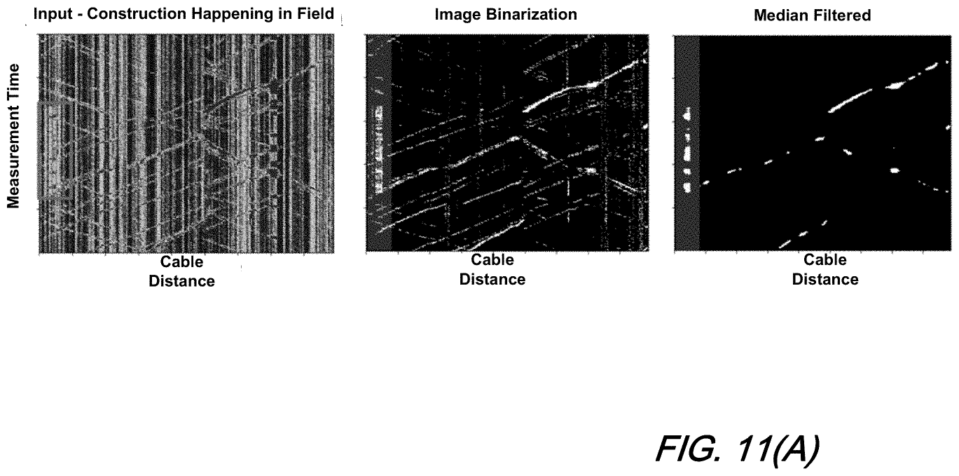

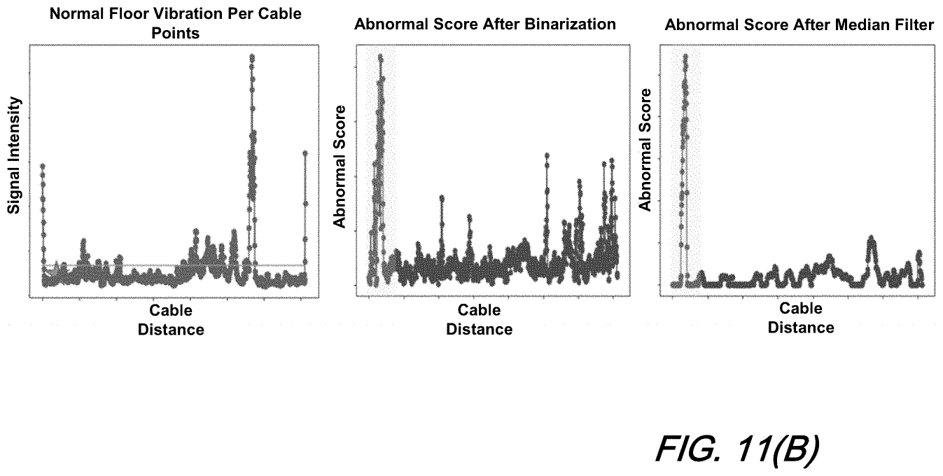

FIG. 11(A) and FIG. 11(B) are a series of plots illustrating a third test example of an excavator hitting a fiber optic cable according to aspects of the present disclosure.

These figures exhibit different construction events (e.g., excavator digging and/or striking the fiber optic sensor cable or other objects) occur at different locations and time as examples to demonstrate that anomaly events can be discovered with correct location identification according to aspects of the present disclosure.

Finally, our inventive system may advantageously generate the following illustrative outputs.

O-1: Display

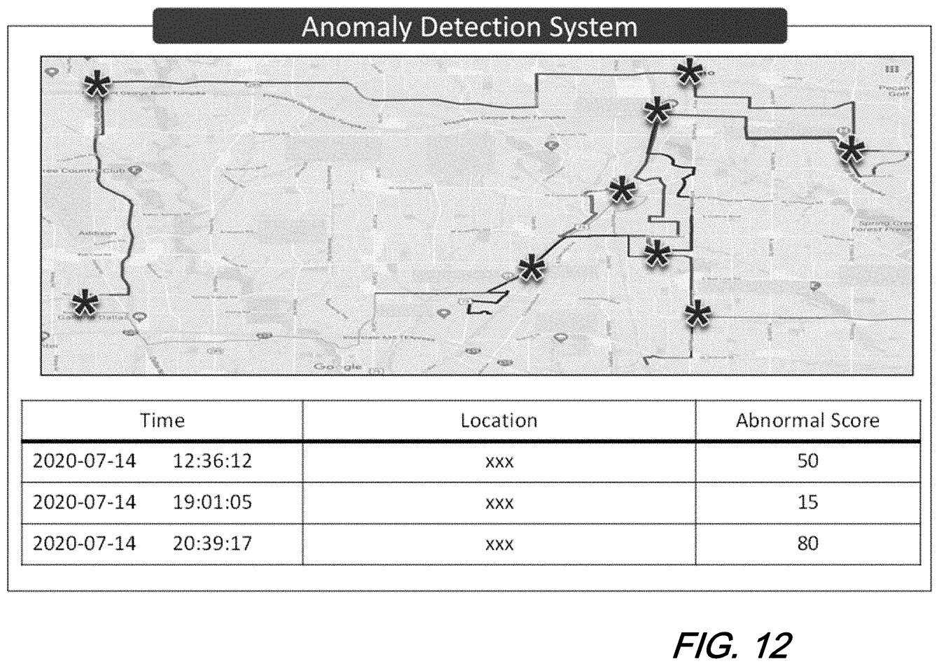

FIG. 12 is a schematic diagram showing an illustrative display of an anomaly detection system according to aspects of the present disclosure and illustrates a display image which includes cable route information and detected anomaly signals with abnormal score to provide a visualize result to carriers. Based on the abnormal scores, the technician can make decisions to check field activities

Experimental

We may now present our experimental efforts to evaluate our inventive systems and methods and demonstrate their effectiveness at predicting/preventing activities that threaten the integrity and/or operation of fiber optic cables.

As we have previously shown and described, our fiber optic sensing technology can advantageously sense vibration signals within tens of meters from buried fiber optic cables. Most such vibrations are caused by normal activities such as traffic. Notwithstanding, and according to aspects of the present disclosure, a critical warning message may be triggered when a sensed vibration pattern(s) do not match to any known, normal activities, and a source location of such vibrations is predicted/determined to be within a protected area proximate to the fiber optic cable. Accordingly, aspects of the present disclosure describe both abnormal activity detection and threat assessment modules in an illustrative cable safety protection system. Advantageously, an additional localization module/method may be employed to pinpoint location of the event(s)—i.e., the GPS coordinates of the event(s)—along the length of the fiber optic cable and present such location as part of a display/report of a geographic information system (GIS).

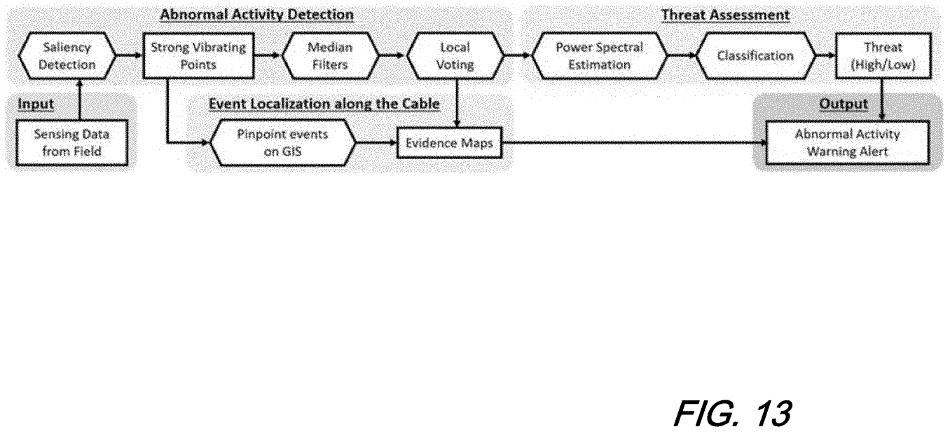

FIG. 13 is a flow diagram showing an illustrative fiber optic cable safety protection system operation from input sensing to output warning according to aspects of the present disclosure. As may be observed from that figure, our inventive system and method includes the operations previously noted namely, input, abnormal activity detection, threat assessment, event localization, and output.

With reference to that figure, we note that first, a saliency detector detects/determines individual strong vibration points from spatial-temporal data resulting from DFOS operation. To accommodate the fluctuation of background noises, an interquartile range (IQR) based metric is adopted in which vibrations fall above the 3rd quartile by more than 1.5× interquartile range are determined as saliency points.

Second, a cause of a group of salient points is determined collectively based on their spatial-temporal patterns. Different from normal traffic(s)—which induces linear slopes—digging and rolling machine operation may generate ripple and strip patterns, respectively. Such patterns can be recognized using median filters with prespecified footprints.

Third, the evidence of abnormal activities may be assessed by calculating the percentage of filtered points exceed abnormal threshold within a local window. This procedure can further reduce the number of false alarms.

The next step is threat assessment. Flagged abnormal events are considered a high threat to the fiber optic cable if the vertical distance between the source and the cable is small—less than a predetermined distance.

According to a frequency-dependent attenuation mechanism, low frequency waves usually penetrate further than high frequency one. This mechanism is investigated in the context of fiber optic sensing system under various propagation mediums. Subsequently, a protection radius for the fiber optic cable is determined.

Operationally, a source-agnostic classifier is trained in a frequency domain to predict whether the target is within or outside of the protection range. This information helps decision making with respect to intervention, wherein events/targets located inside/outside of a protected range is considered as high/low threat to the fiber optic cable, respectively,

Field Trial Set-Up and Results

The feasibility of the system were demonstrated in a field trial. This is a route in a metro network, having a length of 21 km including 4-km aerial cables and 17-km underground cables. A fiber optic sensing system is positioned in a remote terminal and connected to one strand of a fiber located in the cable. The fiber is inside a known type of 1728-fiber cable.

For our trial, much of the underground cable is buried at depth of 48-60 inches. The fiber optic sensing technology employed in this trial is distributed acoustic sensing (DAS), wherein an optical pulse train launches into the fiber optic cable and measures a dynamic strain along the fiber using Rayleigh backscatter. The DAS system employs short optical pulses along with on-chip fast processing to enable an equivalent sensor resolution as small as 1 meter at 2K-Hz sampling rate.

Our trial system detected abnormal activity in two field construction scenarios/operations namely, digging and rolling machines. The patterns of digging machine(s) were discovered and advantageously, the simultaneous detection of multiple events originating from different types of machines may be detected. Likewise, rolling machine activity(ies) were discovered as well.

After detecting these construction events (and possibly determining they are abnormal), we next determined whether the event(s) is/are a high or low risk to the fiber optic cable. The next step is to know whether the event is high threat or low risk to the cable.

To make a threat assessment evaluation, frequency-dependent attenuation mechanisms were investigated to determine a protected zone of the cable in both a lab and field environments. One vibrator was used as a signal source to simulate machine engine noise, The source was located from 3˜30 ft to the cable with a 3-ft interval. Contemporary vibration signals from multiple sensing points on the fiber cable were collected. Average power spectral densities (PSD) estimated by by a known, Welch's method, were determined.

For the purpose of our analysis, windowed signals were categorized in two groups based on the ground truth distance from vibration source to the cable: 3˜12 ft (“+” high threat) and 15˜30 ft (“−”, low risk). Since the vibrator was working at 60 Hz, the harmonic signals at 120 and 180 Hz were induced during the operation. Our results show that frequency attenuation are not significant below 25 Hz, for both grass and asphalt pavement surface conditions. Above that, high frequencies decay quickly with distance.

To induce more variability of sources signals, a jackhammer was also employed to simulate pavement breaking vibrations. Three modes of vibration were generated: (1) vibrator with continuous vibrations, (2) vibrator with intermittent vibrations, and (3) jackhammer with intermittent vibrations. Our field results present similar frequency attenuation characteristics as with the lab testbed, and the separation of two groups by 12 ft holds consistently across all the vibration modes in both studies.

Accordingly, we provided a supervised learning model, trained to automatically determine discriminative frequency components, such that events within or outside the protection radius can be classified accurately. Based on our observation, a linear support vector machine (SVM) classifier was jointly trained on 1206 segments of signal from all three modes, and tested separately on each mode using (non-overlapping) held-out segments. Our results indicate a high detection rate (recall) and low false alarm rate (1-precision). Advantageously the trained classifier generalizes to all the three different types of signal sources, although they exhibit distinct characteristics in the time domain.

At this point, while we have presented this disclosure using some specific examples, those skilled in the art will recognize that our teachings are not so limited. In particular, we have successfully demonstrated abnormal activity detection and threat assessment for fiber optic cable protection with respect to live network, operational telecommunications fiber optic networks. By leveraging fiber optic sensing and machine learning technologies, abnormal events can be discovered and pinpointed at any point along fiber optic cable routes. Additionally, our protection system provides an evaluation of a threat level based on a distance from event(s) to the fiber optic cable and simultaneously defines a protection zone around the fiber optic cable based on the frequency-dependent attenuation mechanism. Once an event within the protection zone is discovered, a critical warning alert can be sent out to operators or systems immediately. The field trial results show that the proposed system can help telecommunications service providers to identify threat constructions near fiber optic cables in real time and prevent fiber optic cable damage. Accordingly, this disclosure should only be limited by the scope of the claims attached hereto.

1. A method of determining abnormal activity and threat assessment to a fiber optic infrastructure, the method comprising
providing a distributed fiber optic sensing (DFOS)/distributed acoustic sensing (DAS) system in optical communication with a fiber optic cable that is part of the infrastructure;
operating the DFOS/DAS to determine baseline vibration levels along a length of the fiber optic cable and storing the baseline vibration levels as associated with particular location(s) along the length of the fiber optic cable;
continuously operating the DFOS/DAS and generating an alarm when a detected vibration event at one or more locations along the length of the fiber optic cable exceeds a pre-determined threshold (cutoff point) relative to the stored baseline vibration levels at those one or more locations.

2. The method of claim 1 wherein the pre-determined threshold at one location along the length of the fiber optic cable is different from the pre-determined threshold at a different location along the fiber optic cable.

3. The method of claim 2 wherein the predetermined threshold for locations proximate to a bridge structure are higher than a predetermined threshold for other locations that are not proximate to a bridge structure.

4. The method of claim 1 wherein the alarm generating procedure takes as input background statistics in normal conditions, location specific and user specified false alarm rate level(s) and determines a location-specific pre-determined threshold for the length of fiber optic cable.

5. The method of claim 4 wherein the alarm generating procedure takes as input a DFOS waterfall plot stream, performs an image binarization on the waterfall plots, performs spatio-temporal filtering on the binarized plots and scores the filtered plots to determine whether to generate the alarm.

6. The method of claim 5 wherein the waterfall plots are provided as snapshots based on a sliding time window.

7. The method of claim 6 wherein abnormal score metrics are determined as a total number of white pixels at each fiber optic cable point within each time window.

8. The method of claim 5 further comprising applying location-specific cutoff points to the waterfall plots to every fiber optic cable position of the length of the fiber optic cable.

9. The method of claim 8 wherein the false alarm rate is set below a certain level according to the following relationship:
Prob[xᵢ>τᵢ|H₀]≤α
where xᵢ is an observed intensity at location i; τᵢ is a cutoff point at location i; α is a pre-specified false alarm level and H₀ is a distribution of intensities when a target signal is not present (baseline).

10. The method of claim 7 wherein an abnormal score is determined as a total number of anomaly pixels from an image.
